(19) United States
(12) Patent Application Publication
(10) Pub. No.: US 2009/0093248 A1
(43) Pub. Date: Apr. 9, 2009

(54) WWAN device provisioning using signaling channel

(75) Inventor: Malayala R. Srinivasan, Andhra Pradesh (IN)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/906,727

(22) Filed: Oct. 3, 2007

(51) Int. Cl. H04Q 7/20

(52) U.S. Cl. 455/433

(57) ABSTRACT

A signaling channel of a wireless wide area network is used to wirelessly obtain network connection information by a wireless device. Such information may include configuration information, branding information, data roaming partner information, and/or subscriber plan information. A user and/or the wireless device may use the network connection information when deciding whether and/or how to connect to the network. A network provider may use methods disclosed herein to efficiently update wireless devices that subscribe to the network. The network provider may provide selected network connection information based on information regarding the wireless device, such as the device location.

### BACKGROUND

Wireless Wide Area Networks (WWANs) are operated by cellular/mobile phone network operators, and the WWANs enable devices to communicate wirelessly over broad areas with other devices or networks. For example, a mobile phone network operator operates a mobile phone network that allows mobile phones (or other mobile devices) equipped to send and/or receive voice may use that network to provide data services to mobile devices using wireless communications. Because,of the nearly ubiquitous nature of the mobile phone network, it can provide a WWAN.

Mobile phone networks use a main communication channel to transmit voice and/or data between the wireless device and the network operator. The mobile phone network uses a signaling channel, separate from the main channel, to transmit supplementary services information between the wireless device and the network operator. For example, a mobile phone user may instruct a mobile phone to send call forwarding information to the network operator, and the device sends the request via a signaling channel to the network operator. A signaling channel also may be used to query available balances for prepaid mobile phone services and may be used to receive other real-time information such as stock quotes. A signaling channel also may be used to transmit instant messages or other types of communications such as electronic mail.

A wireless device is typically associated with a home network operator and, when available, uses the home network for wireless communications. The home network operator may have partner network operators that provide roaming service to the wireless device. That is, the roaming network operators permit the wireless device to connect to the home network via the roaming network when the wireless device is outside of the device's home network's coverage area. A user may desire certain information (such as cost) as an aid to deciding whether to connect to a roaming network, and/or as an aid to deciding to which roaming network to connect. In many cases, the wireless device may be programmed with the identity of one or more voice roaming partner operators of its home operator so that a partner voice roaming network operator can be located when the wireless device is outside of the home network's coverage.

Typically, to establish a data connection with a home WWAN, a wireless device needs to have certain information. For example, a wireless device may possess a set of configuration parameters such as an access point name, a username and a password for establishing a connection with a WWAN.

Before a connection can be made to WWAN for the first time, the configuration parameters (e.g., access point name, username, password) are typically either manually entered by a user who obtains the information by calling a customer service center, or are installed using configuration software.

### SUMMARY OF INVENTION

To expand the utility and ease of use of wireless devices, a signaling channel of a WWAN may be used to wirelessly obtain network connection information by a wireless device. Such information may include configuration information, branding information, data roaming partner information, and/or data subscriber plan information which may include accumulated usage information.

Configuration information includes information used to enable a wireless device to connect to the WWAN. For example, the first time a wireless device attempts to connect with a particular wireless network operator, the wireless device may need an access point name, a username and a password for the home network. According to one aspect of the invention, the wireless device may obtain this information from the network operator by sending a request for such information via the signaling channel of the network. In response, the configuration information may be sent by the network back to the wireless device via the signaling channel. With the configuration information, the wireless device then is able to automatically connect to the network for data and/or voice services.

In the specific case of a Global System for Mobile Communications (GSM) network, the request and/or the configuration information may be transmitted using the signaling protocol of Unstructured Supplementary Service Data (USSD).

By automatically transmitting network connection information, for initial connections, or in cases where information changes due to location of the wireless device or changes on the network operator's side, the burden on both the user and the network operator is reduced, and the rate of errors in obtaining the information is reduced. In some cases, the user can make better informed choices as to network use, and the network operator may maintain better and more efficient control of information distribution.

Other types of network connection information that may be requested and/or transmitted via a signaling channel of the a WWAN include, but are not limited to: branding information such as an operator logo; identifications of data roaming partner network operators; and characteristics of a network subscriber plan, such as use limits or charge structure. The characteristics of a network subscriber plan also may include statistics regarding use of the network as part of the subscriber plan.

One or more of the above types of network connection information may be used as an aid to selecting a roaming network operator, deciding whether to connect to a network, deciding what services to use over the network, and/or other decisions.

The home network provider and/or a third party may provide network connection information to a wireless device, and the specific information to be provided may be determined in response to information about the wireless device, such as its location.

The advantages and benefits described herein are not necessarily intended to be limiting, and some or all of the advantages and benefits do not necessarily need to achieved or implemented for various embodiments to fall within the scope of the invention.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram illustrating an example of a network environment in which information may be obtained or provided over a signaling channel of a wireless wide area network;

FIG. 2 is a flowchart illustrating an example of a method of obtaining information for a wireless wide area network device using some embodiments of this invention;

FIG. 3 is a flowchart illustrating an example of a method of obtaining information for a wireless wide area network device connection manager using the USSD standard on a signaling channel of a GSM network;

FIG. 4 is an example of branding information being displayed on a wireless device;

FIG. 5 is a flow chart of a method of selecting a network with which to initiate connectivity;

FIG. 6 is an example of a user interface of a connection manager showing network options;

FIG. 7 is an example of subscriber plan information being presented to a user on a user interface;

FIG. 8 is a block diagram of one embodiment of a software architecture of portions of a wireless device according to one embodiment of the invention; and

FIG. 9 is a block diagram of a provisioning server according to an embodiment of the invention.

### DETAILED DESCRIPTION

The inventor has appreciated that user experiences with accessing WWANs may be improved by providing a wireless mechanism for the acquisition of certain information related to data network connection and use. More specifically, data network connection information may be obtained via a signaling channel of a WWAN, which may improve the ability of a wireless device to connect to a WWAN, and may inform decision-making as to which network operator to use, whether to proceed with a connection, and which plan to use from a given network provider. This information may be displayed and used for decision making by a user or may be used in an automated fashion within a configuration manager or other component of device to select, create or manage a connection over a WWAN. Additionally, systems and methods disclosed herein may improve a network operator's ability to provide updated information to a wireless device client quickly and easily.

In accordance with aspects of the invention, certain network connection information may be requested, provided and/or obtained over a signaling channel of a WWAN. A signaling channel conventionally is used to transmit supplementary services information between a mobile device and a network operator. For example, a mobile phone user may instruct the mobile phone to send call forwarding information to the network operator, and the device sends the request via a signaling channel to the network operator. In this manner, a connection over a main channel between the mobile phone and the network operator is not required. A signaling channel also may be used to query available balances for prepaid mobile phone voice services, and may be used receive other real-time information such as stock quotes. A signaling channel also may be used to transmit instant messages or other types of communications such as electronic mail. The use of a signaling channel provides a session-based real time communication between the wireless device and the network operator, even if the wireless device is outside the home network's range. Additionally, use of a signaling channel typically does not incur any charges to the user.

In a GSM network, the USSD standard is used to transmit information over a GSM signaling channel. Codes up to 182 characters in length are sent from a wireless device to the GSM network operator via the GSM signaling channel, and a reply from the GSM operator, if applicable, may be sent back to the wireless device via the signaling channel. These communications over the signaling channel can occur prior to a connection being established between the wireless device and the GSM network.

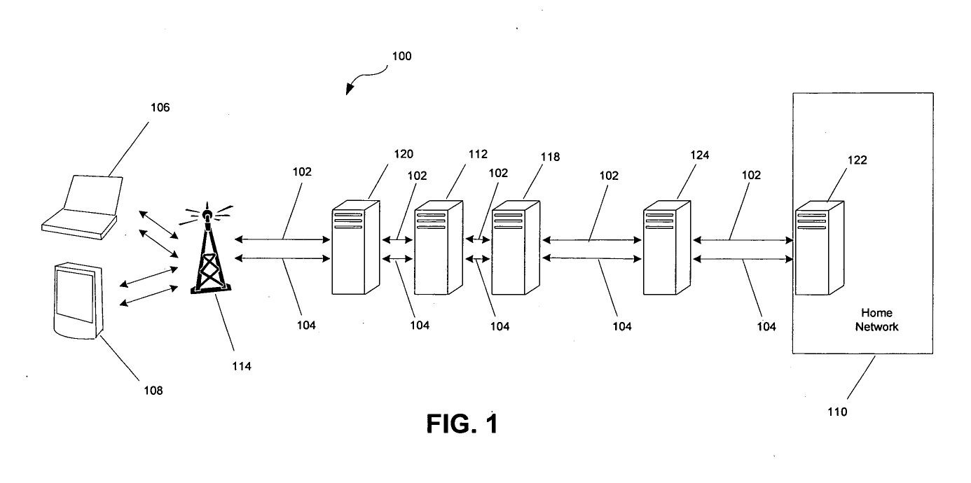

A GSM signaling channel can be used to transmit information between a wireless device and a GSM network operator even if the wireless device is outside of the network operator's home coverage area. For example, as shown in FIG. 1, a network environment 100 may include both a main communication channel 102 and a signaling channel 104 that each can transmit information between a wireless device (e.g. a laptop computer 106 or a PDA 108 and a home network 110. When the wireless device is outside of the home network's coverage area, a Visitors Location Register (VLR) 112 determines the wireless device's location, i.e., which cell tower, such as a Base Transceiver Station (BTS) 114, that the wireless device can contact, and transmits this information to a Home Location Register (HLR) 116. VLR 112 requests various information from HLR 118, such as which services the mobile device is permitted to use. This information is temporarily held in VLR 112, and when the wireless device sends a call setup request message or a data connection request message via BTS 114, a Mobile Switching Center (MSC) 120 handles the request and checks whether the call/connection can be made by examining the information temporarily held in VLR 112.

When network environment 100 provides data transfer capabilities, home network 110 may provide various services to the wireless devices over main communication line 102, such as access to the internet, or access to various networks and/or devices which provide other services, such as printing for example. For a wireless device having both voice and data transfer capabilities, the data transfer capabilities may be provided by a network operator that is different from a network operator providing voice capabilities.

Each of these components (BTS 114, MSC 120, VLR 112, HLR 114) also may be used to transmit requests and information over a signaling channel 104. In this manner, information may be transmitted between the wireless device and home network 110 over signaling channel 104 even when the wireless device is outside the home network's coverage area. In embodiments where network environment 100 includes a GSM network, signaling channel 104 may be configured to transmit information according to the USSD standard. However, any suitable type of network and any suitable signaling channel may be used.

According to one aspect of the invention, a request for network connection information may be sent from the wireless device to a provisioning server 122 via signaling channel 104. In response, provisioning server 122 sends the requested network connection information to the wireless device, also via signaling channel 104. Provisioning server 122 may be implemented in any suitable way. For example, it could be a dedicated server for handling requests for network connection information, or it may be an existing general purpose server with a provisioning service module. An optional USSD gateway 124 may be included to route requests for network connection information to suitable modules within provisioning server 122.

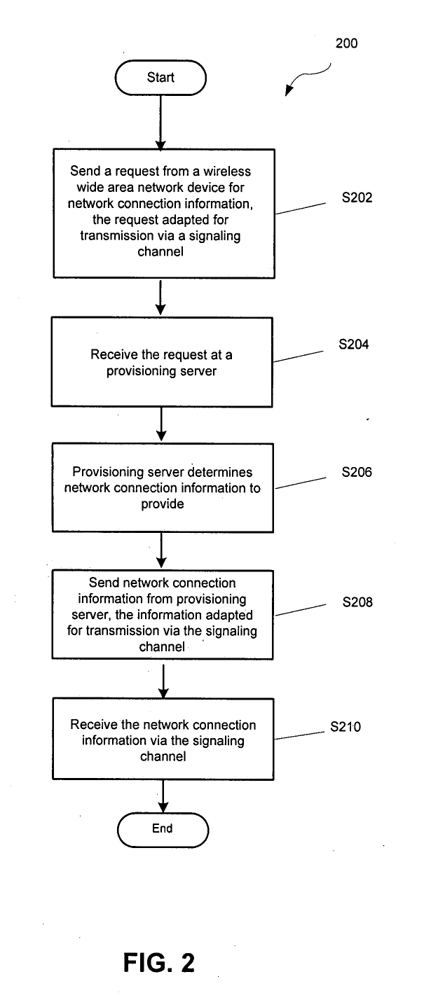

FIG. 2 shows a flowchart of a method 200 of obtaining network connection information for a wireless wide area network device. In an act S202, a request is sent from a wireless wide area network device, the request being adapted for transmission to a provisioning server via a signaling channel of a WWAN. The request includes elements defining a request for connection information. In an act S204, the request is received at a provisioning server. In an act S206, the provisioning server determines what network connection information to provide. For example, the provisioning server may determine what username and password to provide based on the type of subscriber plan (e.g., broadband or GPRS/EDGE).

In some embodiments, the home network may know the location of the wireless device and may determine which approved data roaming network or networks to identify to the wireless device. A provisioning server in a home network may learn the location of the wireless device through information communicated in the signaling channel. For example, a signaling message may contain information that indicates that location of BTS 114 through which the wireless device connects to the network. However, any suitable mechanism for obtaining location information may be used. In this manner, a targeted identification of approved data roaming network(s) may be provided to the wireless device. In an act S208, the provisioning server sends the network connection information, and the information is adapted for transmission via the signaling channel.

In an act S210, the WWAN device receives the network connection information from the provisioning server via the signaling channel. In some embodiments, the network connection information may include one or more of: configuration information (such as a username and password); network operator branding information (such as an operator logo); an identification of a data roaming network approved for use; and data subscriber plan information associated with the wireless wide area network device. The data subscriber plan information may include details of the type of connection (e.g., broadband or GPRS/EDGE) that the user subscribes to, or may include statistical information regarding usage rates (e.g., amount of data downloaded or time spent connected to the network). Such information facilitates selecting a connection or connection options and/or forming a connection to a wireless network and/or managing the connection once established.

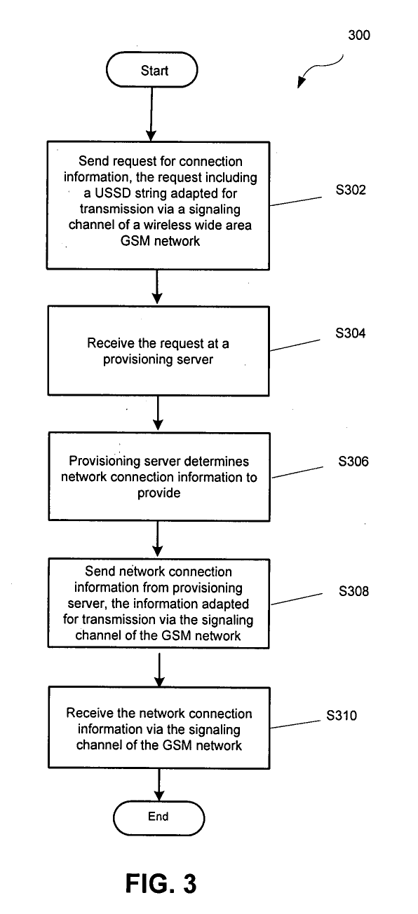

FIG. 3 shows a flowchart of a method 300 of obtaining network connection information for a wireless wide area network device connection manager. In an act S302, a USSD string is sent from a wireless wide area network device, with the USSD string being adapted for transmission to a provisioning server via a signaling channel of a WWAN. In the embodiment illustrated, the WWAN is a GSM network, and the USSD string includes a sequence of characters defining a request for network connection information. The request is received at a provisioning server in an act S304.

The provisioning server determines what network connection information to send in an act S306. For example, as discussed above, in some embodiments, the home network knows the location of the wireless device and determines which approved data roaming network or networks to identify to the wireless device. In this manner, a targeted identification of approved data roaming network(s) may be provided. The provisioning server then sends the network connection information, the information being adapted for transmission via the signaling channel of the GSM network.

In an act S310, the network connection information is received from the provisioning server by the wireless wide area network device, for example by the connection manager, via the signaling channel. The network connection information may include one or more of: an access point name; a username; a password; an operator logo; an identification of a data roaming network approved for use; data subscriber plan information associated with the wireless wide area network device; or other suitable network connection information.

For example, the first time a wireless device attempts to connect with a particular wireless network operator via a GSM network, a request for configuration information (e.g., access point name, username, password) may be sent by the wireless device via a signaling channel of the GSM. The request may be sent using the signaling protocol of Unstructured Supplementary Service Data (USSD). In response, the configuration information may be sent to the wireless device via the signaling channel. With the configuration information, the wireless device then is able to connect to the GSM network for data and/or voice services.

As a result of automatically obtaining the configuration information via the signaling channel, human input errors are reduced when compared to one conventional method of having the user call the network operator's customer service center and then manually enter the information. In cases where the user re-installs an operating system, for example on a laptop computer having wireless capabilities, providing the configuration information over the signaling channel may eliminate the need to manually re-enter the information or re-install wireless communication software after the operating system re-installation. If the network operator changes any one of the access point name, the username, or the password, each wireless device client needs to be updated, and methods and systems disclosed herein can update this information on the wireless device clients.

Types of WWANs other than GSM networks may use some or all of the aspects of the systems and methods disclosed herein. For example, aspects of the invention may be implemented in connection with CDMA and WiMax wireless networks.

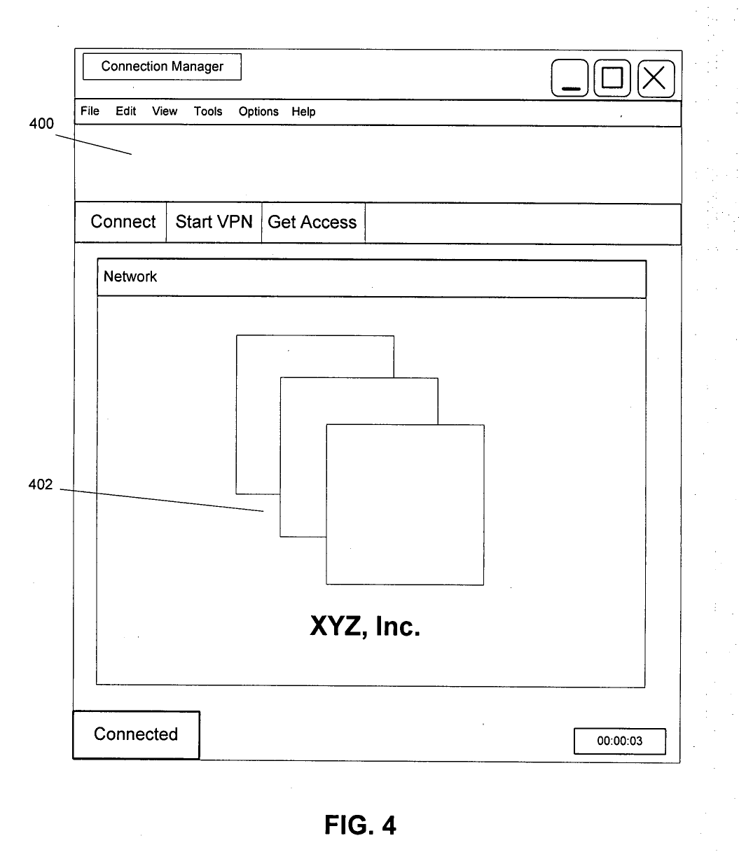

Many wireless network operators require their logo or other branding information to be displayed to the user, for example in a user interface of a connection manager on a wireless device. One example of an operator logo 402 being displayed in a user interface 400 is shown in FIG. 4. Operator logo 402 may appear in user interface 400 of a connection manager before a connection is established with the network operator, e.g., when available networks are being displayed. Operator logo 402 also may be displayed upon connection to the network operator. If the network operator changes its logo or other branding information, providing the updated logo to a wireless device via a signaling channel reduces offline manual processing. Wirelessly providing operator branding information over a signaling channel provides the operator with an efficient, automated method of performing this update. Additionally, an upgrade of an operating system on a wireless device may require another acquisition of the operator logo, and provisioning of the logo via the signaling channel can reduce the burden on the user and/or network operator.

Home network operators typically have approved partner roaming network operators so that wireless devices can initiate or maintain a connection outside of the home network's coverage area. Identifications of approved voice roaming partner networks are often provided to wireless devices and updated via a signaling channel in order to facilitate discovering suitable roaming voice networks. The inventor has appreciated that even though wireless devices having access to a data service that is carried in a main channel of a cellular telephone network, a preferred provider for the data services may be different than a preferred provider for voice services in a particular area. Moreover, some devices, such as laptop computers do not use voice services. Accordingly, information about a preferred voice roaming partner may be non-existent or may not be useful in selecting a provider of a data service.

Additionally, because the home network operator can receive location information regarding a wireless device, the home network can provide an identification of one or more approved data roaming networks to a wireless device based on the wireless device's location. In this manner, the home network operator does not have to reveal its entire list of approved data network partners each time the wireless device desires roaming service, but can instead provide a targeted identification one or more approved data roaming networks.

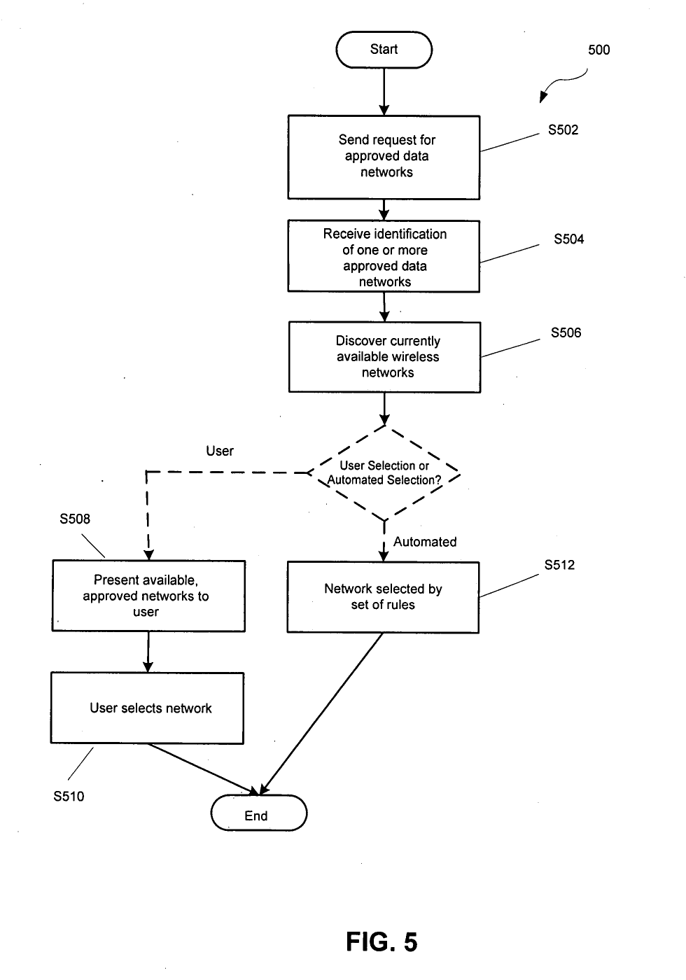

FIG. 5 shows a flowchart of a method 500 of selecting a data network when a wireless device is outside of a home network's coverage area. As part of the method, an identification of one or more approved roaming data network operators is received via a signaling channel, and the identification may be specific to the location of the wireless device.

In an act S502 of method 500, a wireless device sends a request, via a signaling channel, for an identification (e.g., a list) of one or more approved roaming data network operators. If the request is made over a GSM network signaling channel, the request may be made according to a USSD standard.

In an act S504, the wireless device receives an identification of one or more approved data network operators. In some embodiments, the home network of the wireless device determines the present location of the wireless device and sends identifications of data network operators approved for use near the location of the wireless device. In other embodiments, the wireless device may receive a complete list of all approved data network providers regardless of the location of the wireless device.

In an act S506, the wireless device discovers wireless data networks that are available based on signal strength. The wireless device may search for all available wireless data networks, and then limit the choices based on the list of approved data networks. Or, in some embodiments, the wireless device may start with the list of approved data networks and check the signal strength of each approved data network to verify its availability.

In some embodiments, when multiple data networks are available, the selection of which data network to connect with may be performed by the user. In such embodiments, a device connection manager may present the available, approved data networks to the user in an act S508, optionally with additional information such as signal strength, connection speed, and cost information. The user then selects a data network operator in an act S510.

In some embodiments, the wireless device selects which network operator to use based on a set of rules in an act S512. For example, the identification of approved network operators received from the home network operator may include a hierarchy of approved network operators, and the wireless device may select the available network operator having the highest rank. In other embodiments, a connection manager may include an algorithm which selects a network operator based on additional factors such as signal strength, connection speed, and cost. Information to evaluate these rules also may be transmitted over signaling channels.

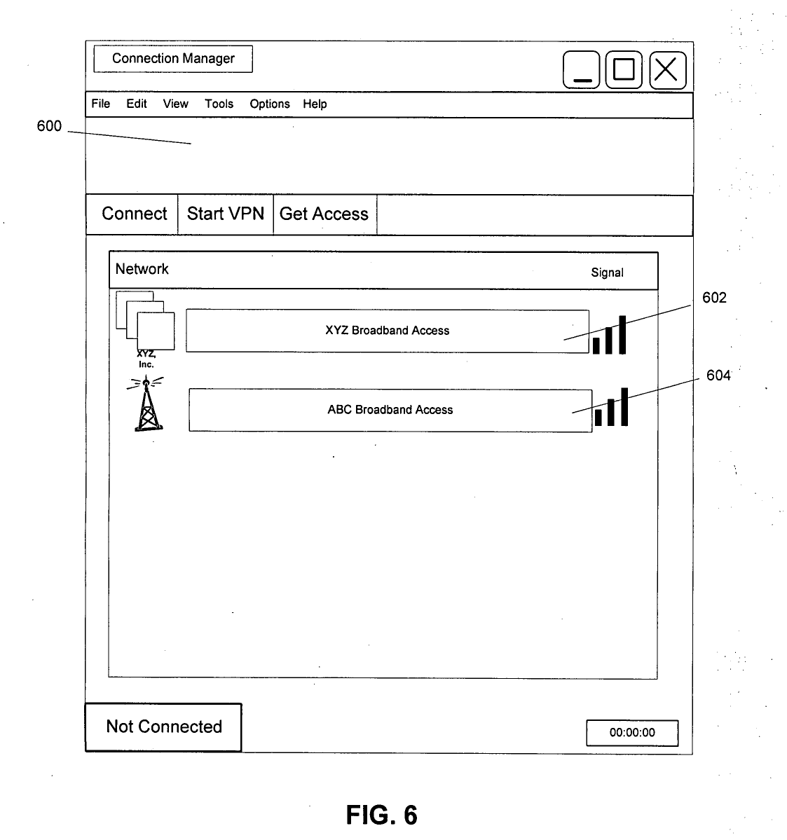

One example of a user interface 600 presenting roaming data network options 602, 604 to a user is shown in FIG. 6 to allow for selection of a roaming network operator. As discussed above, optional information regarding signal strength, estimated connection speed and cost may presented as part of the presentation to the user.

Discovering the characteristics of a user's network subscriber plan can allow the user and/or connection management software to make an informed decisions regarding use of the network, for instance, whether to proceed with further use of the network.

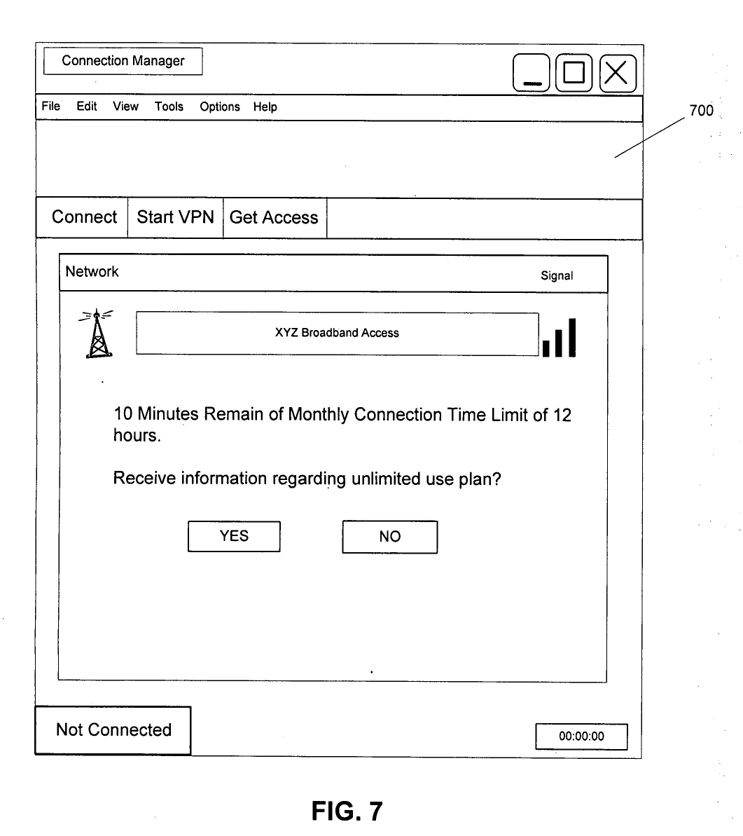

FIG. 7 shows a user interface 700 presenting network subscriber plan information to a user. By informing the user as to various characteristics of the subscriber plan and/or statistical information regarding past usage of the network, the user may be better equipped to make decisions regarding continued use of the network.

For example, the subscriber plan may have a data subscription plan that allows a specified amount of data to be downloaded for a set rate. Above the specified data download amount, the user is charged per kilobyte of use. By receiving updates and/or alerts as to one's current accumulated usage statistics, a user can make informed of choices as to what services to use at a given time. In the example illustrated in FIG. 7, the data subscriber plan is limited to a certain amount of connection time per month, and the user is offered the opportunity to receive further information regarding an alternative plan based on an update as to time remaining. Further, the date of expiration of a data subscriber plan may be made available to a user via the signaling channel. For these types of information, and other suitable types of statistical information, it may be beneficial to the user to be able to retrieve the information via a signaling channel so that connection to the network can be avoided, particularly if the user is concerned about consuming data and/or time allowances.

In some embodiments, options to change subscriber plans with the same network operator or other information that allows a user to select a connection may be presented to the user. The wireless device and/or the network may be configured to alert the user when the use of the network nears a limit, such as a data use total that would start accumulating additional fees. In such a situation, the network may provide to the wireless device, via a signaling channel, alternative subscriber plans that might better suit the user's needs.

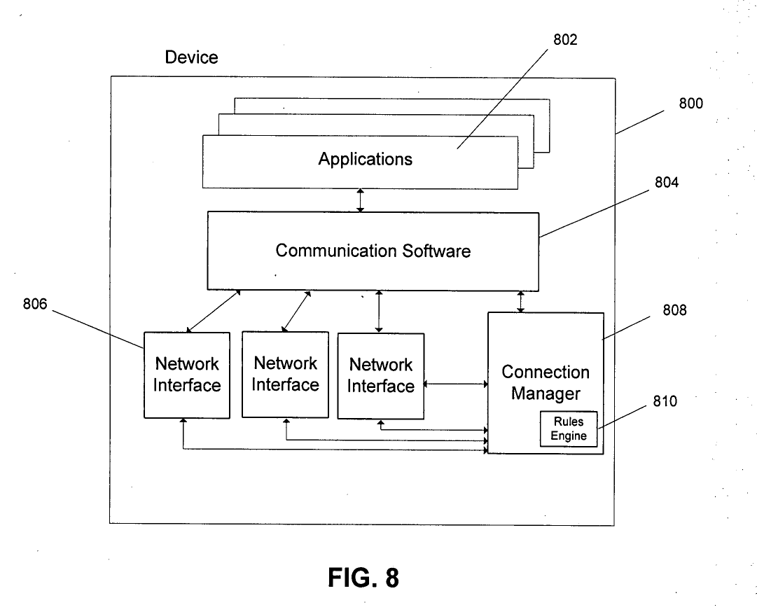

FIG. 8 shows one embodiment of software architecture 800 of portions of a wireless device including various modules, which may be implemented as software modules. One or more applications 802 may run on the device. A communication software module 804 connects applications 802 to one or more network interfaces 806 and to a connection manager 808. Network interfaces 806 may communicate with data networks and/or voice networks. Connection manager 808 may be implemented in any suitable way. For example, it could be a discrete software module dedicated to managing the connection of the device to networks, or it could be a number of modules dispersed throughout the device, which in combination serve to manage connection of the device to networks. Connection manager 808 may include a rules engine 810 that is configured to determine actions to be taken in response to received network connection information. Rules engine may be updated with data and/or rules via information received over a signaling channel of a network.

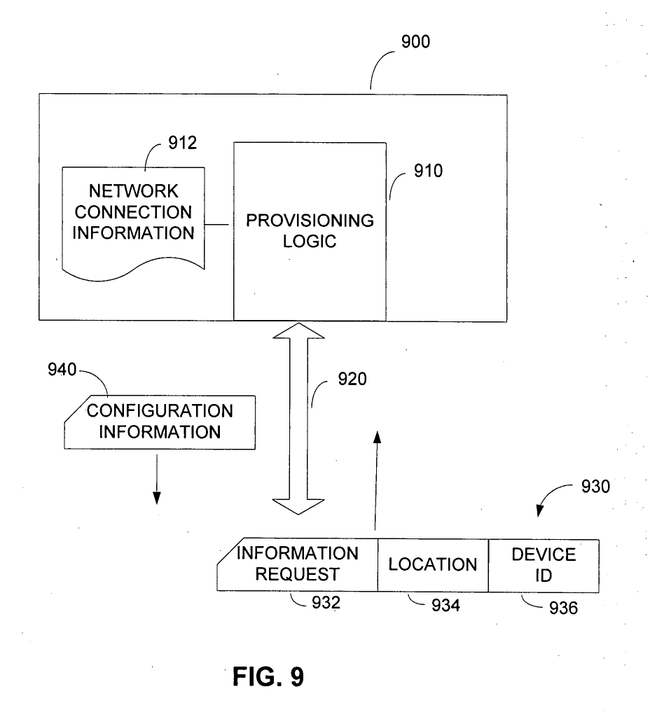

FIG. 9 shows one embodiment a provisioning server 900 including various modules, which may be implemented as software modules. Provisioning server 900 may be operated by a data service provider to provide information related to that data service. For example, provisioning server 900 may be operated by a cellular telephone network operator that also provides optional data services to subscribers.

In the embodiment illustrated, provisioning server 900 is connected to a signaling channel 920 of a network over which data services are provided. Provisioning logic 910 receives information over a signaling channel 920. For example, that information could be in the form of a message 930 initiated by a wireless device seeking to connect to a data service and relayed through a BTS in the vicinity of the wireless device.

Message 930 may include one or more fields. In the embodiment of FIG. 9, message 930 includes fields 932, 934 and 946. Field 932 contains a value identifying the message as a request for configuration information.

Field 934 may contain information identifying the location of the wireless device. This information may be direct location information, possibly obtained from the device itself. Alternatively, the information may indicate the location of a network device in the vicinity of the wireless device. For example, the location of a BTS receiving a signal from the wireless device may be inserted in the message by the BTS as it routes message 930 to provisioning server 900. However, location information may be obtained in any suitable way.

Field 936 may contain information identifying the wireless device or a user of that device. The information may identify the device using a device ID typically used in a cellular telephone network. The device may include an identifier, such as a cellular telephone number or a device identifier. Alternatively or additionally, field 936 may contain user or device authentication information assigned by a network or other information that may be programmed into a wireless device accessing a network. However, any suitable type and source of identification information may be used.

Regardless of the specific information in message 930, provisioning logic 920 may use that information to identify network connection information from a store 912 of network connection information. In this embodiment, store 912 may be one or more databases or other data structures storing one or more types of network connection information. The information may be stored by location, allowing provisioning logic to select network connection information based on the value in field 934 or other information on location of the wireless device. Alternatively or additionally, the information may be stored based on the identity of either a user or device. For example, store 912 may contain information about service plans subscribed to by users. Provisioning logic 920 may then access store 912 to provide network connection information specific to a user or a device.

It should be appreciated that the invention is not limited to executing on any particular system or group of systems. Also, it should be appreciated that the invention is not limited to any particular distributed architecture, network, or communication protocol, unless specifically recited in the claims.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Particular implementation details of computer systems that may execute aspects of the invention will now be described. These implementation details are provided by way of example only, and the invention is not limited to any particular implementation.

Various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

Methods described herein, acts thereof and various embodiments and variations of these methods and acts, individually or in combination, may be defined by computer-readable messages tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Computer-readable messages embodied on one or more computer-readable media may define instructions, for example, as part of one or more programs that, as a result of being executed by a computer, instruct the computer to perform one or more of the functions described herein, and/or various embodiments, variations and combinations thereof. The computer-readable media on which such instructions are embodied may reside on one or more of the components of any of systems described herein, may be distributed across one or more of such components, and may be in transition therebetween. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

The computer-readable media may be transportable such that the instructions stored thereon can be loaded onto any suitable computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. For example, various aspects of the invention may be implemented as specialized software executing in a general-purpose computer system, for example, on wireless device 106 or 108 and/or a peripheral device. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components. The computer system also may include one or more input devices, for example, a keyboard, mouse, trackball, microphone, touch screen, or digitizing tablet and one or more output devices, for example, a printing device, display screen, speaker. In addition, the computer system may contain one or more interfaces that connect the computer system to a communication network (in addition or as an alternative to the interconnection mechanism.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

It should be appreciated that the invention is not limited to executing on any particular system or group of systems. Also, it should be appreciated that the invention is not limited to any particular distributed architecture, network, or communication protocol unless specified as such in a claim.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Having now described some embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. The foregoing description and drawings are by way of example only. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. The use of “including,” “comprising,” or “having,” “containing,” “involving,” and variations thereof herein, is meant to encompass the items listed thereafter and equivalents thereof as well as additional items.

What is claimed is:

1. A method of obtaining network connection information for a wireless wide area network device, the method comprising:
sending a request from a wireless wide area network device, the request being adapted for transmission to a provisioning server via a signaling channel of a wireless wide area network, the request comprising elements defining a request for network connection information; and
receiving, by the wireless wide area network device, the network connection information from the provisioning server via the signaling channel.

2. The method of claim 1, wherein the network connection information comprises one or more of: configuration information; network operator branding information; an identification of a wireless data roaming network approved for use; and data subscriber plan information associated with the wireless wide area network device.

3. The method of claim 1, wherein the network connection information comprises data subscriber plan information, and the method further comprises:
selecting whether to initiate connection with the wireless wide area network.

4. The method of claim 1, wherein the network connection information comprises network operator branding information, and the network operator branding information comprises a network operator logo.

5. The method of claim 1, wherein the network connection information comprises an identification of an wireless data roaming network approved for use, and the method further comprises selectively initiating a connection with the approved wireless data roaming network in response to the network connection information.

6. The method of claim 1, wherein the network connection information comprises data subscriber plan information, and the data subscriber plan information comprises one or more of: information regarding the speed of the data subscriber plan; information regarding the billing type of the data subscriber plan; and a date of expiration of the data subscriber plan.

7. The method of claim 1, wherein sending a request comprises sending a request adapted for transmission to a provisioning server via a signaling channel of a WiMAX network.

8. The method of claim 1, wherein sending a request comprises sending a request adapted for transmission to a provisioning server via a signaling channel of a CDMA network, and the network connection information comprises one or both of: network operator branding information and data subscriber plan information associated with the wireless wide area network device.

9. The method of claim 1, wherein receiving the network connection information from the provisioning server occurs prior to connection of the wireless wide area network device to the wireless wide area network.

10. The method of claim 1, wherein receiving the network connection information by the wireless device comprises receiving the network connection information by a connection manager of the wireless device.

11. A method of obtaining network connection information for a wireless wide area network device connection manager, the method comprising:
sending a USSD string from a wireless wide area network device, the USSD string adapted for transmission to a provisioning server via a signaling channel of a wireless wide area GSM network, and the USSD string comprising a sequence of characters defining a request for network connection information; and
receiving, by the wireless wide area network device connection manager, the network connection information from the provisioning server via the signaling channel.

12. The method of claim 11, wherein the network connection information comprises one or more of: an access point name; a username; a password; an operator logo; an identification of a wireless data roaming network approved for use; and data subscriber plan information associated with the wireless wide area network device.

13. The method of claim 11, wherein the network connection information comprises an identification of an wireless data roaming network approved for use, and the method further comprises selectively initiating a connection with the approved wireless data roaming network in response to the network connection information.

14. The method of claim 11, wherein the network connection information comprises data subscriber plan information, and the method further comprises:
selecting whether to initiate connection with the GSM network.

15. The method of claim 11, wherein receiving the network connection information from the provisioning server occurs prior to connection of the wireless wide area network device to the GSM network.

16. At least one computer-readable medium having computer-readable instructions for performing steps of a method of instructing a wireless wide area network device to retrieve network connection information from a provisioning server, the method comprising:
sending a request from a wireless wide area network device, the request being adapted for transmission to a provisioning server via a signaling channel of a wireless wide area network, the request comprising elements defining a request for network connection information;
receiving by the wireless wide area network device the network connection information from the provisioning server via the signaling channel, the network connection information comprising one or more of: configuration information; network operator branding information; an identification of a wireless data roaming network approved for use; and data subscriber plan information associated with the wireless wide area network device.

17. The computer-readable medium of claim 16, wherein the network connection information comprises data subscriber plan information, and the method further comprises:
displaying the data subscriber plan information on a user interface; and
requesting user input regarding whether to initiate connection with the wireless wide area network.

18. The computer-readable medium of claim 16, wherein sending a request comprises sending a USSD string adapted for transmission to a provisioning server via a signaling channel of a GSM network.

19. The computer-readable medium of claim 16, wherein sending a request comprises sending a request adapted for transmission to a provisioning server via a signaling channel of a WiMAX network.

20. The computer-readable medium of claim 16, wherein sending a request comprises sending a request adapted for transmission to a provisioning server via a signaling channel of a CDMA network, and the network connection information comprises one or both of: network operator branding information and data subscriber plan information associated with the wireless wide area network device.
